(19) United States
(12) Patent Application Publication
(10) Pub. No.: US 2006/0071549 A1
(43) Pub. Date: Apr. 6, 2006

(54) Electronic controlled vacuum powered brake system for towed trailers

(76) Inventors: Ronald Chesnut, Banning, CA (US); Douglas Stewart, Whittier, CA (US)

Correspondence Address: GREENBERG & LIEBERMAN, LLC, 2141 WISCONSIN AVE, N.W., SUITE C-2, WASHINGTON, DC, 20007, US

(21) Appl. No.: 10/948,931

(22) Filed: Sep. 24, 2004

(51) Int. Cl. B60T 13/74

(52) U.S. Cl. 303/123; 303/3; 303/15

(57) ABSTRACT

A vacuum powered assisted dual piston master brake cylinder and associated calipers are applied to trailers. The present invention can be applied to, but is not limited to boat, horse, travel, fifth wheel and utility trailers. The main components of the present invention are as follows: a vacuum power assisted master cylinder with two outlet ports of hydraulic power, a vacuum pump, a solenoid, an electronic power module, and a dash control module. The power brake unit is directly connected by lever arm to the solenoid of the towed vehicle.

### FIELD OF THE INVENTION

The present invention is a system of electronically controlled vacuum assisted power brakes for towed trailers. Specifically, the present invention is a digital electronic control of a vacuum assisted power hydraulic disc brake system installed in trailers to compensate for the excessive stopping distances of the towing vehicle caused by the increased mass and weight of the towed trailer and cargo.

### BACKGROUND OF THE INVENTION

There are many types of vehicles and mobile storage units for carrying extra cargo; including, but not limited to travel trailers, fifth wheel trailers, boat trailers, horse trailers, utility and cargo trailers. These trailers are necessary to transport large animals such as a horse, for moving a second vehicle, a mobile residence, a boat, or cargo from one location to another. Each trailer is mechanically attached to a powered towing vehicle such as a car, tractor, truck, motorized recreational vehicle or other vehicles capable of towing. An inherent problem in this situation is that the towing vehicle's brakes are intended to stop only the towing vehicle, its passengers and cargo and not the additional weight that is added from a towed trailer. In more recent model cars or trucks with ABS systems, the brake systems cannot be invaded because the loss of even one ounce of fluid will cause these computerized systems to fail, therefore, invasion of the existing hydraulic or air system is not a viable option.

Virtually all states have laws making a braking system mandatory at some level of the trailer's gross weight rating. Chassis manufacturers recommend that trailers exceeding 1000-1500 pounds have their own brake system, which can be activated simultaneously with the towing vehicle's brakes. In order to safely transport the cargo, vehicle or animals, the trailers are made in varying shapes and capabilities, and usually have a locking removable mechanical coupling attachment to the various types of towing vehicles.

Many trailers on the market have no braking systems. This creates the possibility of a dangerous situation for traveling with trailers. The first situation is that the trailer may separate from the towing vehicle, and with no brakes, the trailer will have no emergency stopping function and will have to rely on hitting a structure or vehicle of equal or more weight to come to a stop. This can create crashes between the trailer and oncoming vehicles with property damage, personal injury or death to passengers, and damage to the goods enclosed.

Also in trailers with no braking system or an ineffective braking system, there is an inherent problem when relying on the towing vehicle's brakes to stop both vehicles. The inertia of the trailer does not allow the combination to slow at the same rate as the towing vehicle alone. This situation puts the strain of the towing vehicle and the trailer with its cargo directly on the brakes of the towing vehicle. The towing vehicle's brakes are not intended to create the amount of braking force that is required to stop the towing vehicle, the trailer and its cargo in a smooth and safe manner. Trailers with no brakes or ineffective brakes may cause an additional load on the towing vehicle's brake system sufficient to cause overheating or other failures thus increasing the stopping distance and jeopardizing the safety of the towing vehicle and its passengers. Trailers with no brakes or a delayed action of those brakes may also cause jack-knifing or rollovers of the trailer causing the towing vehicle to collide with other vehicles or stationary objects such as guard rails or abutments.

One of the available options for braking on trailers is the electro magnetic braking system. The electro magnetic braking system consists of a friction faced electro magnet contacting a disc attached to a conventional brake drum. Electric current is applied to the magnet causing the magnet to attempt to adhere to the disc as it rotates with the wheel. The magnet mechanically actuates the brake shoes as it attempts to rotate with the rotating disc causing the brake shoes to expand resulting in the slowing of the trailer. Electro magnetic brakes are unlike the present invention because they have a delay in reaction time. They also do not function as well in reverse as they do in forward motion. They are difficult to repair in comparison to other types of trailer brakes and often require maintenance. They are not instantaneous in their braking action. Electro-magnetic brakes are also expensive and difficult to repair and are susceptible to damage from weather, water or time-based corrosion.

There are also surge hydraulic systems available for trailers. Hydraulic surge brakes function by using a non-rigid coupler between the towing vehicle and the trailer to apply mechanical movement to a piston in the master cylinder. This mechanical movement of the coupler will vary depending on the angle between the trailer behind the towing vehicle and the amount of braking force created by the towing vehicle's brakes. The movement of fluid in the master cylinder then transfers to the wheel cylinders causing the brake shoes or pads to expand to slow the trailer.

Surge hydraulic systems are unlike the present invention because they have an inherent delay at start of operation and optimum pressure cannot be reached by these systems to utilize the full braking potential of disc brakes. On long downhill grades they can apply constant braking pressure to the trailer because of the forward motion caused by gravity on the coupler creating excessive wear and heat on the trailer brakes. Because the towed vehicle pushes against the towing vehicle to generate hydraulic braking pressure there is always an excessive load on the towing vehicle's brakes in normal stops causing premature wear and possibly failure of the towing vehicle's brakes. Surge hydraulic brake systems have no independent manual operation and are not instantaneous. Surge brakes must also have a manual lockout so they will not and cannot apply the brakes when backing up.

Another system of brakes available on the market for trailers is electric hydraulic. Electric hydraulic brake systems function by using an electric motor-driven pump to create the hydraulic pressure to apply to the brake system. Electric hydraulic brake systems are unlike the present invention because they are not able to build instantaneous pressure. They also do not have the capability to instantaneously vary the hydraulic pressure to accurately control the amount of braking force required.

There are also vacuum hydraulic systems available. Vacuum hydraulic systems basically work by piping any vacuum system in the towing vehicle with an installed vacuum hydraulic system in the trailer. The vacuum hydraulic system functions specifically by piping the engine manifold vacuum from the towing vehicle to the trailer to operate the vacuum braking system in the trailer. The vacuum hydraulic systems are unlike the present invention because they do not function instantaneously. Because vacuum hydraulic systems function by piping the towing vehicles engine manifold vacuum to the towed trailer, there is a possibility of failure in this piping system that will cause the loss of braking on the trailer. The leak created by the piping failure may cause the towing vehicle's engine to quit or at least perform poorly and can also degrade or cause to fail any vacuum systems in the towing vehicle which usually includes its brakes.

The present invention will function with diesel engines. Vacuum hydraulic systems will not function with diesel engines, as diesel engines do not create manifold vacuum. This is crucial because diesel powered vehicles are widely used to tow heavy loads such as trailers.

Thus, known braking systems available for trailers are either electric, surge, electric-hydraulic, vacuum or a combinations of these. With the electric-hydraulic systems, a pump is necessary to build up pressure sufficient to make the towed vehicles brakes operate effectively. Any time delay to build up sufficient trailer braking pressure means the stopping distance will be increased by the delay time of the trailer brakes being applied.

Further, disc brakes are the only type of brakes that can approach instantaneous actuation because they require infinitesimal mechanical brake pad movement upon application of hydraulic pressure. It is desirable to employ disc brakes on trailers because disc brakes can be nearly instantaneously actuated; however, there is a need for a braking system that creates sufficient pressure applied to the disc brakes to make them more effective and so that there is no delay attributable to the creation of hydraulic pressure. Electric, surge, electric-hydraulic, vacuum or combination systems are unlike the present invention because they are not capable of quickly applying sufficient hydraulic pressure to the disc brakes to make them instantaneous, fully progressive, fully proportional, non-invasive to the towing vehicle's brake system, and capable of mirroring the brake effort of the towing vehicle. A big plus is the low maintenance of disc brake systems.

U.S. Pat. No. 6,609,766 issued to Chesnut on Aug. 26, 2003, shows an instantaneous, progressive and proportional braking system for a towing vehicle and a towed vehicle. Unlike the present invention, Chesnut's device utilizes the towed vehicles existing vacuum power assisted braking system. Chesnut's device is not meant, nor does it teach or suggest any way to brake a trailer that does not have a previously installed vacuum power assisted braking system. Therefore, a need has been established for a braking system applied to trailers that operates in an instantaneous manner, mirrors the braking system of the towing vehicle to brake the towed vehicle simultaneously and provide sufficient hydraulic pressure to the disc brake system. None of the related art taken either singly or in combination is seen to describe the present invention as claimed.

### SUMMARY OF THE INVENTION

The present invention is a digital electronically controlled vacuum assisted power disc brake system for trailers. The present invention takes the technology of a vacuum power assisted dual master cylinder and the associated disc brake calipers used in the automotive and trucking industries and applies it to trailers. The present invention applies the technology of digital electronic controls to the technology of vacuum power assisted disc brakes on trailers including, but not limited to the following types; utility, horse, travel, boat and 5th wheel.

The problem has been how to apply nearly instantaneously pressure to a brake system in a trailer. According to the present invention, disc brakes are used on a trailer to provide the fastest response time to a braking signal from the towing vehicle. Audio and safety information is relayed back to the driver of the towing vehicle as to the operational status of the trailer disc brake system. The key to the present invention is providing deceleration information of the towing vehicle to the trailer so the trailer brakes can be applied appropriately.

The electronic components are divided into separate modules. The first module is located inside the towing vehicle and contains an inertia-sensing device to determine the stopping or braking of the towing vehicle. This first module attaches electrically, for a source of power to the battery of the towing vehicle and to the brake light switch for part of the control information. The inertia-sensing device is progressive so the harder the brakes of the towing vehicle are applied, the harder the brakes will be applied on the trailer and the lighter the application of the brakes on the towing vehicle, the lighter the application of the brakes on the trailer.

The first module also has a gain control device, adjustable by the towing vehicle operator, to adjust the proportion of braking force on the trailer, in relation to that of the towing vehicle to compensate for load, road conditions, traffic and terrain. The first module has a manual slide control that allows the operator of the towing vehicle to apply the brakes of the trailer manually without applying the brakes of the towing vehicle. This slide control is important because the trailer is oftentimes much heavier than the towing vehicle and thus the trailer will decelerate much more slowly than the towing vehicle. If the towing vehicle is not slowing with the same force as the trailer, manual intervention is necessary to prevent the trailer from pushing the towing vehicle. For example: if the towing vehicle is not decelerating quickly as on an icy road, the trailer will decelerate even slower because it has a greater load than the towing vehicle. The trailer can cause a jackknife to occur because the trailer is pushing the skidding towing vehicle possibly causing an accident or even death. With the manual slide control, the operator of the towing vehicle can force the trailer brakes to be applied even though the deceleration of the towing vehicle would normally not cause the trailer brakes to be applied.

The first module has a visual display and audio alarms to alert the towing vehicle operator of breakaway, low hydraulic pressure, low hydraulic fluid and split system failures. This is possible because the braking system of the trailer is built according to the present invention, as opposed to tethering an existing braking system from the trailer to the towing vehicle. There is also a check for vacuum leaks and a visual display to alert the operator of such a system failure. The first module communicates through digital signals to a second module through a wire or other forms of communication. The first module hereinafter referred to as “controller” and the second module hereinafter referred to as “trailer module” are shown and described as one unit for explanation simplification. Actual systems may have one or more of either module. The trailer module receives power from a battery installed in the trailer. A wire from the alternator of the towing vehicle continually charges the battery on the trailer. In the current configuration a communication link from the controller communicates braking information from the towing vehicle's controller to the trailer module, which interprets the information and applies an appropriate force to the trailer's brakes. The trailer module also communicates failure information back to the controller that then activates the visual display and emits audio warnings. The trailer module interprets the digital signals from the controller and translates the signal into height and or width modulation of electric current for the solenoid of the trailer. The solenoid uses the height and or width modulated pulses to apply an appropriate mechanical pressure to a lever arm attached to the vacuum booster and master cylinder on the trailer. Deceleration information from the controller is converted to digital pulses, modulated in amplitude and or width in the trailer module, and applies the appropriate current to the electric magnetic solenoid attached to the vacuum power assisted master cylinder of the trailer brake system causing the trailer to brake appropriately.

The trailer module relays the signals to the solenoid using a multi-vibrator output, varying from approximately 20% on and approximately 80% off to approximately 90% on and approximately 10% off, varying the pull force of the solenoid on the lever, to allow for progressive operation of the trailer brakes as supplied by the inertia sensor in the controller. The more braking force sensed by the inertia sensor the higher percentage of on-time signals the multi-vibrator will apply to the solenoid.

The present invention, upon activation caused by the operator of the towing vehicle touching the towing vehicle's brake pedal, sends approximately 20% current to the solenoid to ensure that the brakes of the trailer are applied before those of the towing vehicle. The brake light signal on the towing vehicle enables the relay of digital signals from the controller to the trailer module, activating the solenoid and the trailer brakes before the towing vehicle's brakes are applied. With no other factors involved except the touching of the brake pedal by the towing vehicle's operator, approximately 20% current is sent to actuate the solenoid. This insures that the trailer brakes are applied before the towing vehicle's brakes are applied; this prevents the trailer from pushing the towing vehicle or causing a jackknife.

### BRIEF DESCRIPTION OF THE DRAWINGS

FIG. 1 is a gross view of the components of the present invention and how they communicate with each other.

FIG. 2 is a front view of the control box which will be located in the towing vehicle.

FIG. 3 is a close-up view of the vacuum power assisted hydraulic brake system in the towed trailer.

### DETAILED DESCRIPTION OF THE PREFERRED EMBODIMENT(S)

The present invention is a braking systems for trailers. The present invention can be applied to, but is not limited to boat, horse, travel, fifth wheel and utility trailers. The present invention uses electronically controlled vacuum power assisted hydraulics to achieve the desired result. The present invention has a control box (10), with an internal inertia sensor (20), a power module (30), twelve volt trailer battery (40), solenoid (50), lever (60), vacuum pump (70), vacuum booster (80), master cylinder (90), hydraulic reservoir (100), split system (110), first hydraulic line (101), second hydraulic line (102) and calipers (130). All of; but not limited to these elements are essential for the proper functioning of the present invention.

The present invention, upon being powered up by turning on the towing vehicle's ignition switch (31), performs a test cycle that takes about eight seconds to complete. These tests are necessary to determine that all of the components are functioning properly at the start of travel. This test cycle performs the following functions:

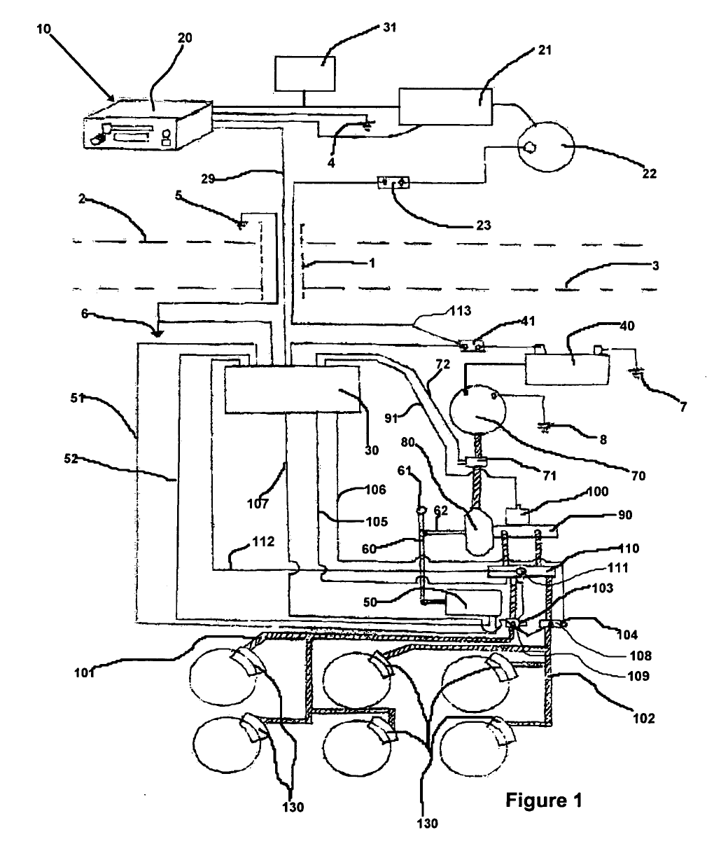

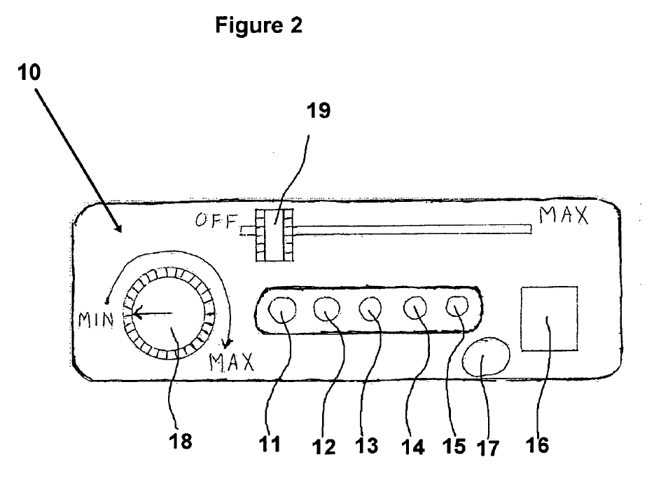

Test 1. Applies maximum braking force to the trailer, test for minimum hydraulic pressure of 1000 PSI, from first pressure switch (103) and second pressure switch (104), both shown in FIG. 1. If either first pressure switch (103) or second pressure switch (1 04) senses a pressure less than 1000 PSI in either line, which could indicate either a leak or clog in the lines, control box (10) alerts the operator by emitting an audio alert and the appropriate visual alerts including the PASS/FAIL light (16) explained in more detail in FIG. 2.

Test 2. Turns on the vacuum pump (70) and after approximately a 3 second delay, test for minimum vacuum of 10 inches by the vacuum switch (71). This test is run twice during the initial power on and constantly during use. If minimum requirements for vacuum pump (70) are not met, vacuum switch (71) will communicate to the power module (30) via vacuum data line (72). The power module (30) will communicate to the operator control box (10) which then emits the proper visual alerts and the PASS/FAIL light (16) illuminates to alert the operator.

Test 3. Tests for sufficient hydraulic fluid. There is a fluid level sensor in the master cylinder reservoir (100). If the hydraulic fluid level is low the sensor in the reservoir (100) signals via data line (91) to the power module (30). The power module (30) communicates via communications line (29) to control box (10) located in the towing vehicle to emit the appropriate audio and visual alerts to the operator including illuminating the PASS/FAIL indicator (16).

Test 4. Tests for split system failure while testing the hydraulic fluid pressure. Split system valve (110) is a shuttle valve which detects a pressure differential in either first hydraulic line (103) or second hydraulic line (104) operating a pressure differential switch (111) sending a fail signal on its data line (112). The power module (30) communicates via communications line (29) to the control box (10) located in the towing vehicle emitting the appropriate audio and visual alerts to the operator.

In the preferred embodiment on control box (10) the red LED (12) will flash upon failure of Test 1. The second LED display (13) will flash at the failure of the vacuum in Test 2. The third red LED (14) will flash if the second test of the vacuum again fails. The fourth red LED (15) display will flash if the brake fluid levels are insufficient. First red LED (12), second red LED (13), third red LED (14), and fourth red LED (15) will flash if output of the slide control is greater than (15) seconds. In the event of any failure PASS/FAIL light (16) will flash. The reset button (17) can reset the audible alarm. The audible alarm is in the control box (10) located on dash of towing vehicle. The audible alarm is also activated upon the cessation of the green LED (11) or if a breakaway situation occurs during normal use. The audible alarm serves the same function as the PASS/FAIL light (16), but notifies the operator of a problem in an audible instead of visual manner.

In an alternate embodiment, the control box (10) will have a digital screen in place of red LED (12, 13, 14, 15) and green LED (11), to indicate failures via test display. The audio alert will still be used in this embodiment.

FIG. 1 displays the layout of the present invention. The components for the towing vehicle and the trailer are externally connected between the towing vehicle and the trailer by umbilical cord (1). Alternate forms of communication are also considered; i.e. radio, infrared, etc. Components located above first dotted line (2) relate to the towing vehicle and components located below second dotted line (3) relate to the attached trailer. The space between first dotted line (2) and second dotted line (3) should be considered the external area between the towing vehicle and the trailer.

Control box (10) is located in the towing vehicle accessible to the operator. As shown in FIG. 1, control box (10) is powered by the towing vehicle's battery (21) when ignition switch (31) is turned on and is grounded at first ground point (4). Like all motor vehicles, battery (21) is recharged by alternator (22). Between alternator (22) and trailer battery (40) is a thirty-amp breaker (23) to protect the wiring between alternator (22) and twelve-volt trailer battery (40). Inside control box (10) is an inertia sensor (20). In an alternate version the inertia sensor may be in a separate module still located in the towing vehicle. Inertia sensor (20) detects when the towing vehicle's brakes create deceleration (negative acceleration) caused by the operator applying pressure to the towing vehicle's brake pedal. When the brake is applied, inertia sensor (20) detects the slowing (negative “G” force) and the control box (10) sends an encoded digital signal through the digital control line (29) that travels through umbilical cord (1) and connects to power module (30). The power module (30) is powered by trailer battery (40) and is also connected through umbilical cord (1) via charge line (113) to alternator (22) for recharging the trailer battery (40). Trailer battery (40) is grounded at second ground point (5) on the towing vehicle and at third ground point (6) on the trailer. Note that trailer battery (40) is grounded at forth ground point (7) and is also connected to alternator (22) via charge line (113) for recharging purposes. A 50-amp breaker (41) between power module (30) and the trailer battery (40) is to protect the wiring between twelve-volt trailer battery (40) and power module (30). Power module (30) converts the digital signals communicated via data line (29) from control module (10) into modulated electrical current. The current is then passed through first solenoid wire (51) and second solenoid wire (52) into solenoid (50). The modulated current causes the solenoid plunger to pull into the solenoid coil (50) creating a mechanical motion with variable pull force. Solenoid (50) has a lever (60) attached to it. The other end of lever (60) is attached to a pivot point (61). Just below pivot point (61) attached to lever (60) is pump rod (62). Pump rod (62) runs through vacuum booster (80) (explained in detail later) and into master cylinder (90). The motion of solenoid plunger (50) causes lever (60) to rotate at pivot point (61) and in turn pushes and pulls pump rod (62) in and out of master cylinder (90) varying the hydraulic pressure.

In addition to sending modulated electrical current to solenoid (50), the power module (30) also communicates with vacuum pump (70). Vacuum pump (70) is used in conjunction with vacuum booster (80) to increase the pressure of the hydraulic fluid stored in the master cylinder (90) supplied by hydraulic reservoir (100). Note vacuum pump (70) is grounded at fifth ground point (8). Vacuum booster (80) multiplies the force applied to lever (60) to increase the pressure of the hydraulic fluid. Pressurized hydraulic fluid is then pumped through first hydraulic line (101) and second hydraulic line (102). First hydraulic line (101) and second hydraulic line (102) pass through split system (120) and continue to calipers (130). Between split system (120) and calipers (130) are first pressure switch (103) and second pressure switch (104). First pressure switch (103) and second pressure switch (104) receive power from power module (30) via first power line (105) and second power line (106) and communicate with control box (10). After braking ceases a third pressure switch (108) and fourth pressure switch (109), communicate via line (107), measuring the residual (if any) pressure of the hydraulic fluid in their respective hydraulic lines. If the pressure is above the desired reading, the respective pressure switch will report back to control box (10) to alert the operator. If at any time the split system differential pressure switch (110) detects sufficient pressure differential it will communicate via power module (30) to control box (10) alerting operator. In turn the split system pressure differential will shut off the appropriate hydraulic line and direct all hydraulic fluid flow through the remaining hydraulic line. This feature allows the trailer to function at half-braking power to enable the operator to continue to use the trailer until the error can be corrected. Although split system (110) has temporarily patched the problem the PASS/FAIL light (16) will still be illuminated to alert the operator that the trailer's brakes are at half-power and operator compensation is needed when braking.

As shown in FIG. 2, the preferred embodiment has, on control box (10), a green LED display ( 11) to indicate normal operation of the trailer braking system. Red LED displays (12), (13), (14), and (15) indicate an error in a corresponding component. Gain control (18) is to control the proportion in which the brakes are applied to the trailer to compensate for its load, traffic, or road conditions. Slide control (19) is for manual operation of trailer brakes without having to apply the towing vehicle brakes.

When a failure occurs the corresponding red LED display (12, 13, 14, 15) indicate a failure by flashing to alert the operator and indicate the exact component creating the error. There is also a PAS S/FAIL light (16) as part of the controller box (10) which flashes continually when triggered, indicating a failure until either failure is corrected or power is removed by turning off the ignition switch (31) in the towing vehicle. Without these alerts the present invention will still perform, however, in the event of a failure the towing vehicle operator will not be informed. If the towing vehicle operator is aware of a failure, the operator can then react appropriately to fix the failure and prevent a dangerous situation that may occur due to that particular failure.

The gain control (18) is set, by the operator, according to the weight of the trailer being towed or the road or traffic conditions. The gain control is set so that the braking force of the trailer is appropriate for its weight and traffic or road conditions to allow the trailer to stop itself without increasing the stress on the towing vehicle's brakes. The inertia sensor (20) compensates for the appropriate distance required to stop. If a long distance is detected by the operator in the towing vehicle, light slowing would be required and light slowing would be done by the trailer. If a short distance is detected by the operator, and a hard stop is required a hard stop will be done by the trailer. Slide control (19) is used to allow the operator to manually control the braking force of the trailer if necessary. Slide control (19) allows the operator to apply the trailer brakes independently from the towing vehicle, to stop more rapidly, or to control swaying.

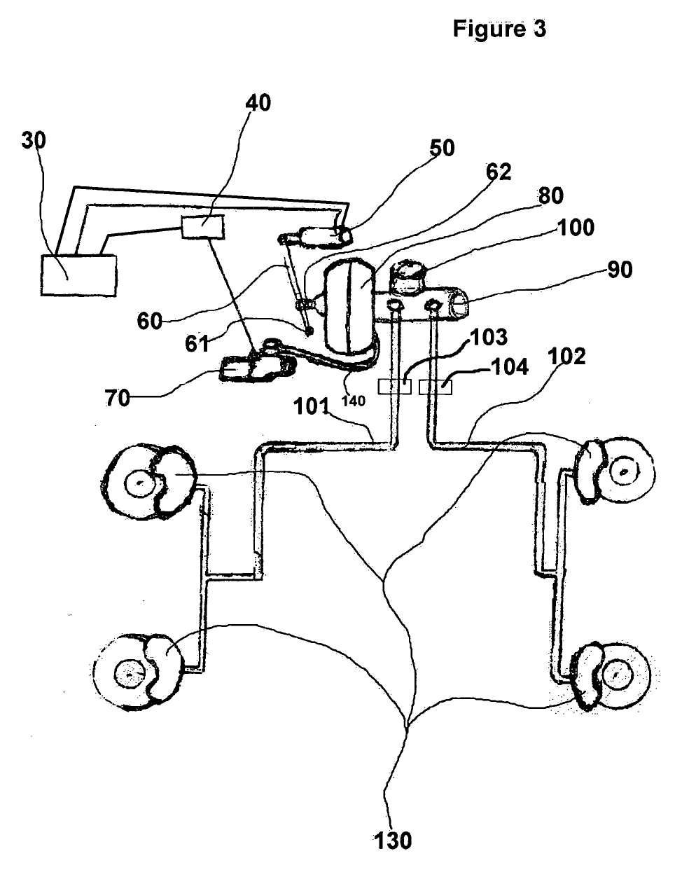

FIG. 3 gives a close-up view of the trailer brake system consisting of the vacuum pump (70), vacuum booster (80), master cylinder (90), solenoid (50) and calipers (130). Calipers (130) are shown attached to the wheels of the trailer. The solenoid (50) and vacuum pump (70) are attached to the power module (30) electrically. Power module (30) relays needed information from the control box (10) (not shown in this figure and located in towing vehicle) to the solenoid (50) and to the vacuum pump (70) to control the action of the trailer's braking system. The master cylinder (90) through piping is connected to the calipers (130) by use of first hydraulic line (101) and second hydraulic line (102) and will pipe the appropriate degree of stopping force needed. The vacuum booster (80) is connected to a lever arm (60) mechanically connected with the solenoid (50). The vacuum pump (70) is electrically connected to power module (30) and piped to vacuum booster (80). Vacuum booster (80) amplifies the mechanical force created by solenoid (50) connected to lever (60) and push rod (62) operating the piston assembly in master cylinder (90) to generate sufficient hydraulic pressure to calipers (130) to effectively stop the towed trailer.

Having illustrated the present invention, it should be understood that various adjustments and versions might be implemented without venturing away from the essence of the present invention. The present invention is not limited to the embodiments described above, and should be interpreted as any and all embodiments within the scope of the following claims.

I claim:

1. A braking system for a towed trailer comprising:
a control box;
a battery in communication with said control box;
a alternator in communication with said battery; and
a power module in communication with said control box.

2. The device of claim 1, wherein said alternator is a conventional automotive alternator.

3. The device of claim 1, wherein said power module is powered by a battery.

4. The device of claim 1, wherein said control box is in communication with said power module via two way digital communication line.

5. The device of claim 3, wherein said battery is 12 volts.

6. The device of claim 3, wherein said battery in located in the towed trailer.

7. The device of claim 1, further comprising an inertia sensor in communication with said control box.

8. The device of claim 7, wherein said inertia sensor is located inside said control box.

9. The device of claim 1, further comprising:
a solenoid in communication with said power module;
a vacuum booster in communication with said solenoid; and
a vacuum pump in communication with said vacuum booster.

10. The device of claim 1, further comprising:
a master cylinder in communication with said vacuum pump;
a hydraulic reservoir in communication with said master cylinder; and
at least one hydraulic line in communication with said master cylinder.

11. The device of claim 10 wherein said at least one hydraulic line is two hydraulic lines.

12. The device of claim 10, further comprising:
a split system in communication with said at least one hydraulic line;
at least one pressure switch in communication with said at least one hydraulic line.

13. The device of claim 12, wherein there are two of said pressure switches.

14. The device of claim 12, wherein said pressure switches are in communication with said power module.

15. The device of claim 10, further comprising at least one caliper in communication with said at least one hydraulic line.

16. The device of claim 14, where in said pressure switches are residual pressure sensors.

17. An electronic controlled power disk brake system for towing a trailer comprising:
a control box with audio and visual displays adjustable for trailer load and having manual operation controls, said control box located in a towing vehicle;
a power module in communication with said control box;
a battery installed in the trailer receiving its charge source from an alternator of a powered towing vehicle;
a vacuum boosted hydraulic disk brake system mechanically connected to a solenoid in communication with said power;
an inertia device, in said control box, initialized by a brake light switch of the towing vehicle, said inertia device determining the appropriate slowing of the towing vehicle;
a battery operated vacuum pump supplying vacuum to said vacuum boosted hydraulic disk brake system in the trailer;
a vacuum sensor, in communication with said power module, said vacuum sensor relaying information to said control box;
multiple pressure sensors monitoring pressures in said vacuum boosted hydraulic disk brake system, said multiple pressure sensors in communication with said power module for relaying instantaneous information to said control box;
a mechanical break-a-way switch in communication with said control box, said mechanical break-a-way switch installed in the trailer, and mechanically tethered to the towing vehicle to provide electronic emergency stopping of the trailer should the trailer and the towing vehicle become separated;
an electrical connection to said brake light switch of the towing vehicle for automatic operation of said vacuum boosted hydraulic disk brake system, and for software initializing said vacuum boosted hydraulic disk brake system prior to the breaks of the towing vehicle causing slowing because of the action by an operator of the towing vehicle;
a manual operator control on said control box, said manual operator control allowing and operator of the towing vehicle to apply said vacuum boosted hydraulic disk brake system without applying a set of brakes in the towing vehicle;
Wherein said power module is electrically connected to said battery, said power module modulates current to a solenoid based on digital information communicated from said control box, so that deceleration of the trailer mirrors the towing vehicle; and
a gain control in said control box, said gain control allowing an operator to adjust for various loads so that the towing vehicle and the trailer receive appropriate proportional breaking force.
